(19) United States
(12) Patent Application Publication
(10) Pub. No.: US 2002/0116471 A1
(43) Pub. Date: Aug. 22, 2002

(54) Broadcast and processing of meta-information associated with content material

(75) Inventor: Yevgeniy Eugene Shteyn, Cupertino, CA (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/789,906

(22) Filed: Feb. 20, 2001

(51) Int. Cl. G06F 15/16

(52) U.S. Cl. 709/217; 709/201

(57) ABSTRACT

Meta-information is included with the broadcast of content material. The meta-information contains information for accessing available content material, and contains characterizing information related to the material. This information includes, e.g., a synopsis, a list of performers or characters, a genre, and so on. The access information may include, for example, a scheduled broadcast time, an access channel, a URL identifier, a source provider, purchase information, and so on. Generally the meta-information consumes substantially less memory or bandwidth than the broadcast content material. A processing device at the user's broadcast receiver is configured to process this information-rich meta-information corresponding to a large volume of available content material to facilitate filtering of the available material, or automating or optimizing the selection process. A provider of the content material can use the meta-information to convey advertisements, information related to purchasable content material, and so on, to enhance revenues.

### BACKGROUND OF THE INVENTION

1. Field of the Invention

This invention relates to the field of consumer electronics, and in particular to the broadcast and subsequent processing of meta-information related to content material.

2. Description of Related Art

A variety of schemes are available for providing content material, such as audio or audio-video entertainment or information material, to a variety of users. For ease of reference, the term “broadcast” is used herein to include providing content material via wireless or wired systems, or combinations thereof, as well as multicast, peer-to-peer network and distribution via discrete media such as discs and other memory devices. Generally, broadcast includes any method of conveying information without a specific identification of the intended recipient, or without regard for whether an identified recipient actually receives the communicated material, as compared to directed, or point-to-point communications.

Audio/Video broadcast includes conventional radio and television transmissions via wireless or wired means, HDTV, streaming video over the Internet, multicast, downloaded audio or video files from the Internet, peer-to-peer network, distributed discs and other media, and so on.

With the availability of a wide variety of broadcast content material, a variety of schemes have been developed or proposed for facilitating the access to the material, and for facilitating selection from among a variety of available material. PCT Application WO 98/26584, “INTERNET TELEVISION PROGRAM GUIDE SYSTEM”, published Jun. 18, 1998 for Boyer et al, and incorporated by reference herein, presents a scheme for accessing an electronic program guide that is available via the Internet. The user is able to search for particular types of content material, to view clips related to the content material, to program audio-video devices, such as televisions and VCRs to tune in to specific broadcasts, and so on. The user accesses this system via a personal computer, a set-top-box, or an Internet-enabled television system.

The TiVo® and ReplayTV® are commercial systems that facilitate the selection of content material based on user preferences. A user can, for example, express an interest in “golf”, and in response to this expressed interest, the system subsequently records broadcast programs that are related to “golf”, for subsequent viewing by the user. Alternatively, the system can “learn” from the user's past selections, or from the user's feedback regarding past selections, and thereafter autonomously select and record broadcast content material that is likely to be of interest to the user.

Each of the conventional systems require access to a secondary source of information, such as the Internet or proprietary databases containing information related to the content material, and each require a computer access to this secondary source.

The Teletext system, which is prevalent in Europe, adds data to a broadcast program in the vertical blanking period. This data is being broadcast cyclically, and the user accesses this data by tuning to the proper channel via a Teletext decoder and then waits until the proper Teletext page comes by. The Teletext data is structured for display purposes, and is not in a structured form that facilitates access to alternative sources of information.

### BRIEF SUMMARY OF THE INVENTION

It is an object of this invention to provide a method and apparatus to facilitate access to content material, without requiring a user access to a secondary source. It is a further object of this invention to provide a method and apparatus to facilitate selection from among a variety of available content material, without requiring a user access to a secondary source. It is a further object of this invention to provide a method of enhancing potential revenues to a broadcast provider by providing access and selection services for receiving or purchasing content material.

These objects and others are achieved by including meta-information with the broadcast of content material. The meta-information contains information for accessing available content material, and preferably contains characterizing information related to the material. This characterizing information may include, for example, a synopsis, a list of performers or characters, a genre, and so on. The access information may include, for example, a scheduled broadcast time, an access channel, a URL identifier, a source provider, purchase information, content processing instructions, control codes, and so on. Generally the meta-information consumes substantially less memory or bandwidth than the broadcast content material. A processing device at the user's broadcast receiver is configured to process this information-rich meta-information corresponding to a large volume of available content material to facilitate filtering of the available material, or automating or optimizing the selection process. A provider of the content material can use the meta-information to convey advertisements, information related to purchasable content material, and so on, to enhance revenues. One or more providers can combine multiple types of meta-data with the content material. The receiver of the combination of the content material and the meta-data can extract a particular type of meta-information at a time, depending upon the receiver configuration, the user's subscription options, and so on. In a home environment, meta-data can be forwarded to networked devices that are dedicated to processing such meta-data.

### BRIEF DESCRIPTION OF THE DRAWINGS

The invention is explained in further detail, and by way of example, with reference to the accompanying drawings wherein:

FIG. 1 illustrates an example block diagram of a broadcasting and a receiving system in accordance with this invention.

FIG. 2 illustrates an example block diagram of a meta-information processing system in accordance with this invention.

Throughout the drawings, the same reference numerals indicate similar or corresponding features or functions.

### DETAILED DESCRIPTION OF THE INVENTION

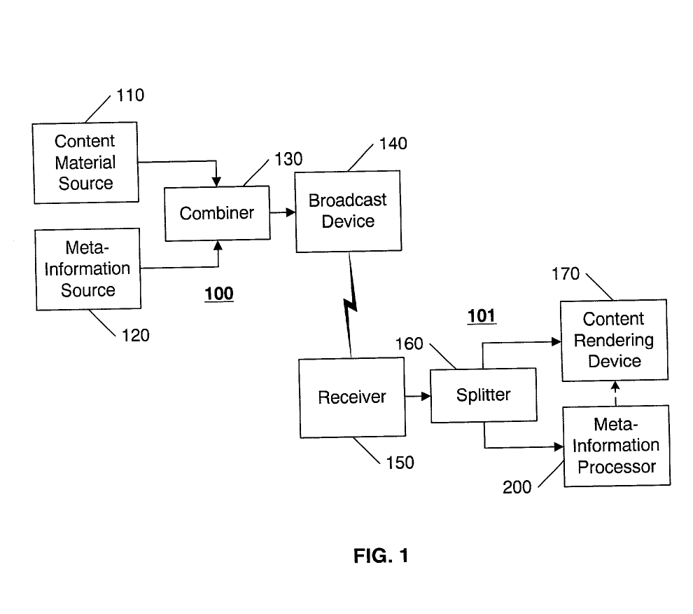

FIG. 1 illustrates an example block diagram of a broadcasting system 100 and a receiving system 101 in accordance with this invention. The broadcasting system 100 includes a source of content material 110, a source of meta-information 120, a combiner 130, and a broadcast device 140. For the purposes of this invention, content material 110 includes a plurality of discrete segments of material, such as individual songs, movies, sports events, news stories, entertainment programs, and so on.

The meta-information 120 contains information related to the content material 110, or related to content material from other broadcasting systems (not shown), or related to available material from other sources. Meta-information is defined herein as information that is structured to facilitate subsequent processing of the information, using, for example, any of a variety of “Mark-up Languages” (HTML, XML, and so on) that allow for the marking of information items. Information related to a recorded song, for example, includes the title, the artist, the composer, the length, available sources, and so on. Without a defined structure, however, a processing system may not be able to distinguish which items of text correspond to the title, which text corresponds to the artist, and so on. Via the use of a mark-up language or other information structuring scheme, the text items are identified as particular information-bearing fields, such as a “title” field, an “artist” field, and so on, thereby forming a “meta-information” set that facilitates subsequent processing, such as a search routine that finds all music by a particular “artist”, or all “titles” containing a particular phrase, and so on.

Generally, the meta-information 120 refers to segments of material that are currently being broadcast, or scheduled to be broadcast in the future, but it is not necessarily limited to present and future material. The meta-information 120 may contain information regarding material that was broadcast in the recent past, or information regarding material not yet scheduled to be broadcast, and so on. This meta-information 120 includes, for example, an identification of the segment, a synopsis, a list of performers, one or more genres associated with the segment, a broadcast schedule, access information, links to other sources of information related to the segment, and so on. The access information may include, for example, the television channel or radio frequency that a user's receiving device is to be tuned to receive the information, or the Universal Resource Locator (URL) of an Internet site from which the material can be downloaded, or from which a live-feed transmission can be received.

The access information in the meta-information may also include information related to the purchase of the content material, for example, for pay-per-view broadcasts, or to purchase an individual copy of the material, via CD, DVD, VCR tape, and so on. Copending U.S. patent application Ser. No. “METHOD AND SYSTEM FOR PURCHASING CONTENT RELATED MATERIAL”, U.S. Ser. No. 09/498,261, filed Feb. 3, 2000 for Nicholas Mankovich, Michael Epstein, and Toine Staring, Attorney Docket US000036, incorporated by reference herein, discloses a system for supporting impulse purchases that are based on content material that is received by an entertainment device. The referenced patent application discloses the use of a “buy” button on the receiving device to place a purchase request for an item that is associated with the segment of the content material that is currently being presented, and is incorporated by reference herein. For the purposes of this invention, a “purchase” includes any exchange of value, including but not limited to a debit to an account, a redemption of points or other items, such as frequent flyer miles, advertising coupons, a submission of information, such as profiling information related to the user, and so on.

The meta-information may also include information for providing feedback to the provider of the content material, or the providers of the individual segments of the content material. The access information, for example, may include one or more URLs for expressing interest in particular segments, or one or more toll or toll-free numbers for “voting” on the particular segment, and so on. This feedback may be used by the provider(s), for example, to adjust the broadcast schedule for the particular segment, to formulate a broadcast schedule for materials in the same genre, to target particular broadcasts to particular classes of recipients, and so on.

The meta-information may also include information for facilitating access to other sources of information regarding the segment, or for facilitating access to other recipients of the broadcast segment. Copending U.S. patent application, “CHAT-TV WITH ROOM CREATION BY TIME OF DAY”, U.S. Ser. No. 09/221,947, filed Dec. 28, 1998 for K. Travato, P. Rankin, and C. Ramsey, Attorney Docket PHA 23,556, incorporated by reference herein, discloses a system for creating or joining a chat-room on the Internet, based on the time of day, and other information, such as a determination of the broadcast station to which the user's television is tuned. The chat-room facilitates commentary on the currently broadcast segment of content information, such as comments from fans during the broadcast of a sports event. In accordance with this invention, the meta-information may include the URL of such a chat-room, to facilitate a dialog among users who share a common interest in the referenced segment of the content material.

The meta-information may also be a “script” corresponding to programming code that can be executed at the user site. This script may be in a common language, such as “JavaScript”, or in a special-purpose language, such as an encoding that is specific to a particular vendor's product. For example, the meta-information corresponding to a television program guide may contain a script that directly programs a user's remote control device to automatically record a selected program at its scheduled broadcast time and channel. In like manner, the script may be coupled with other features, such as parental controls, to effect actions based on a combination of parameters, including parameters that are stored at the user site.

The meta-information may be encoded using a proprietary as well as a public format, or a combination of both. The meta-information may also be based on database information, or other conventional means for indexing and accessing information. U.S. Pat. No. 5,920,856, “SYSTEM FOR SELECTING MULTIMEDIA DATABASES OVER NETWORKS”, issued to Syeda-Mahmood on Jul. 6, 1999, and incorporated by reference herein, discloses a network server that comprises a meta-database and search agent that distributes queries to other databases, based on a correlation of a user's query to the information in the meta-database. The meta-information of this invention may correspond to a meta-database as taught by the referenced patent, or it may correspond to a URL or other identifier of the meta-database. In a preferred embodiment, the meta-information includes information that is encoded using the Extended Markup Language (XML), with tags indicating location, availability, price, schedule, and other characteristics of the associated content material.

In accordance with this information, the meta-information is combined with the content material, via the combiner 130, to form a composite data set, and subsequent broadcast via the broadcast device 140. The broadcast device 140 may be a conventional radio or television broadcast device, such as an RF transmitter or a cable or satellite headend transmitter, or it may be a server on the Internet or other network that is configured to provide live feeds (“streaming” audio and/or video material), multicast, or downloads of stored content material, or combinations of both. For the purposes of this invention, the broadcast device 140 also includes an interface to a third-party provider of broadcasting services. That is, for example, a television network may create the composite data set and communicate it to local transmitting stations, cable providers, web servers, and so on. In like manner, a particular program of content material may be ‘syndicated’, via a distribution to a variety of third-party broadcasters. The provider of the syndicated program may effect the combination of content material with meta-information, and provide the composite data set to the third-party broadcasters, via an interface that corresponds to the broadcast device 140. That is, although a direct connection is indicated by the communications link between broadcast device 140 and receiver 150, the communication of the composite data set from the device or interface 140 may be via one or more intermediate communication systems or networks.

The broadcast device 140 may also be configured to communicate the composite data set to one or more receivers via discrete media, such as via CDs and DVDs. That is, for example, the meta-information may be included with the audio content of a conventional CD, and it may provide the aforementioned information regarding the particular segment(s) contained on the CD, and information that facilitates a cataloging of the segments for subsequent access and selection by the user (discussed below), as well as the aforementioned information regarding access to similar content material, or access to other information related to the particular segments.

In a preferred embodiment of this invention, the meta-information is selected for inclusion with the content material such that the meta-information related to a particular segment of the content material consumes significantly less memory or bandwidth than the segment itself. In this manner, while transmitting one segment of content information, meta-information regarding a plurality of segments of content material can be transmitted. By including meta-information regarding other segments of content material, the provider of the broadcast, or the provider of the composite data set, can potentially realize increased revenues, via, for example, a user's selection of future pay-per-view material referred to by the meta-information, via a targeting of future content material and/or meta-information, based on feedback facilitated by the meta-information, and so on. In like manner, the meta-information may include content processing instructions, control codes, and so on, wherein viewers who subscribe to premium services are provided higher-quality renderings, based on the processing of the content material using particular codes.

The providing of meta-information regarding a plurality of segments of content material also provides opportunities for third-party information providers to increase revenues. Broadcasters will likely acquire a large portion of the meta-information that is provided with the content material. If one provider of an electronic program guide, for example, provides more accurate or more informative meta-information than another provider, broadcasters are likely to select the more accurate information, and potentially pay a higher fee for this information, because users are likely to be influenced in their selection of content material based on the quality of the co-transmitted meta-information. That is, for example, if a user is undecided between viewing material from two different broadcasters, the user may make the decision based on the quality of the electronic program guide that is available while the user views the selected material. In like manner, the user may be more likely to “jump to” a particular broadcast channel during commercial breaks on another channel, based on the quality of the meta-information that is provided by the broadcast channel. Often, having jumped, viewers become interested in the material presented at the “jumped-to” station, and do not return to the original “jumped-from” channel.

The receiving system 101 of FIG. 1 includes a receiver 150, a splitter 160, a content rendering device 170, and a meta-information processing device 200. As with the broadcast device 140, the receiver 150 may be any of a variety of means for receiving the composite data set that is communicated from the broadcast system 100. The receiver 150 includes, for example, a terrestrial RF receiver, a satellite receiver, a cable signal receiver, a web access device, a playback device, and so on. The splitter 160 segregates the composite data set that is received by the receiver 150 into the original content material, and the associated meta-information.

The content rendering device 170 includes any of a variety of conventional devices that are configured to render, or prepare for rendering, or store for future rendering, the received content material. The device 170 includes, for example, a video display system, an audio system, a recording system, and/or an interface to other systems, such as devices or appliances that are located on a home network (not shown) to which the receiving system 101 has access.

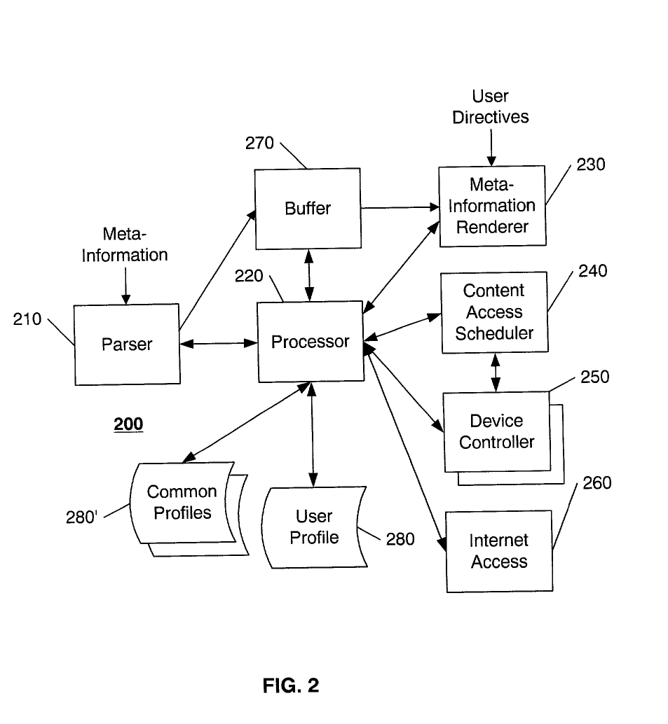

FIG. 2 illustrates an example block diagram of a meta-information processing system 200 in accordance with this invention. The processing system 200 includes a parser 210 that parses the meta-information, a processor 220 that processes the parsed meta-information, and a variety of example devices 230-260 that effect actions based on the processed meta-information items. The processor 220 manages the interactions among the components of system 200.

In a straightforward embodiment of this invention, a meta-information renderer 230 presents the meta-information to a user, and receives user directives, based on the rendered meta-information. For example, upon command by a user, an electronic program guide may be presented to the user, with options for current or future selection and/or recording. As illustrated, the parser 210 and processor 220 have access to a buffer 270, to facilitate the creation of particular composites of the meta-information. For example, the meta-information may be a stream of information regarding a variety of segments of content material, and the processor 220 and/or parser 210, may organize the received meta-information into a viewable program guide, including but not limited to organizing and presenting the meta-information based on time, genre, user preferences, broadcast provider, and so on.

The renderer 230 provides the user the option to effect a variety of actions. Via the processor 220, the user can control the content access schedule 240 to access a particular segment of content material immediately, or at a scheduled time in the future. The content access scheduler 240 in a preferred embodiment is also configured to effect the appropriate exchange of information to purchase the relevant access rights, such as required for pay-per-view access. The scheduler 240 or the processor 220, or both, are configured to also control the particular devices that facilitate the rendering of the selected segments of the content material, via one or more device controllers 250. For example, at the scheduled time of access to a selected segment of the content material, a tuner device may be tuned to the appropriate channel or frequency, a recorder device may be activated to record the selected segment, and a notification device may be activated to remind the user that the selected segment is currently being received. Other devices may also be controlled. For example, based on user directives or preferences, the lights in the room may be controlled to provide an appropriate ambiance for enjoying the selected segment of content material, telephones or other potential sources of interruption may be disabled, and so on.

As noted above, the meta-information may contain locators for additional sources of information regarding the content material, each particular segment, related segments, and so on. Access to this additional information is illustrated in FIG. 2 as provided via an Internet access device 260, although other access means may be used, dependent upon the source of the additional information. For example, in lieu of an Internet access via a URL, access to a source may be identified by a telephone number, or a fax number, for direct access to the source of the additional number, via, for example, a dial-up to a proprietary network, a fax-back service, and so on. As with the content access scheduler 240, the access device 260 also includes, in a preferred embodiment, facilities for effecting a purchase of the additional information or items related to the additional information. As indicated by the double-headed arrows between the processor 220 and the elements 230-260, the processor 220 of a preferred embodiment is configured to receive feedback from the access and control elements 230-260 and to effect alternative actions in dependence upon this feedback.

In a preferred embodiment, the receiver 200 includes a dataset corresponding to a user profile 280, or other profiles 280′. The processor 220 uses the information in the profiles 280, 280′ to organize and filter the meta-information for presentation to the user. Additionally, the processor 220 uses the information in the profiles 280, 280′ to effect automated operations as well. For example, as in the aforementioned TiVo® system, a user's preference for a particular genre, performer, etc. can be stored in the user profile 280, and the processor 220 can be configured to automatically initiate recordings of segments that correspond to the user's preference, or automatically download, via the Internet access device 260, additional information related to segments of particular types. The user profile 280 may also provide security measures. For example, different users of the receiving system 101 (of FIG. 1) may have different rights with respect to content access or other information accesses, consistent, for example, with the use of parental controls, office management policies, and so on.

The user profile 280 may be created and modified explicitly or implicitly. In a preferred embodiment, a user is provided the option of specifically identifying genres of interest, including identifying different genre preferences at different times of the day, or on different days. As each segment of content material is received, the user may provide an explicit opinion (typically, “thumbs-up” or “thumbs-down”) for each viewed segment. Additionally, the processor 220 can be enabled to monitor the user's selections, and to develop therefrom a pattern of behavior, and an implicit set of preferences. In a preferred embodiment, the processor 220 includes a learning system that continually updates the user profile 280 based on the user's past behavior. The system may also be configured to combine meta-information with the user profile data. For example, when meta-information contains a description of a song or a book, characteristics contained in the description may be combined with the user's shopping preferences. Similarly information contained in the user's profile 280, such as the user's membership or account information, may be combined with the meta-information to form a proper URL to efficiently access the material being offered via the meta-information.

The processor 220 may also be structured to transfer select information from the meta-information for subsequent use. For example, based on a user's profile, the processor 220 may be configured to automatically store the results of sports events, or an identification of news items related to select topics, for subsequent presentation to a user. The transferred information may also correspond, for example, to a script that is downloaded to another device.

As systems that incorporate this invention become popular, users will discover that some profiles result in a more effective selection or filtering process than others. In a preferred embodiment of this invention, a user may create and maintain a variety of user profiles, each, for example, reflective of particular ‘moods’ of the user. These user profiles are transportable, so that for example, a person having a common interest with another can receive the other user's profile when that profile appears effective for accessing content material related to the common interest. Exchange services, similar to existing services that allow various users to exchange information related to book reviews, movie reviews, etc., can be provided for users to exchange profiles that have proven effective for particular scenarios. A content provider may provide this exchange service, in return for access to the exchanged profiles. Thereafter, the content provider can modify the selection of content material for broadcast, based on the characteristics of profiles that appear to be popular. A user community that is interested in a specific topic, for example, art education for children, can share targeted profiles and/or meta-data processing instruction code through a web site, peer-to-peer network, and other means of communication. The system may also allow remote access to the profile information, so that a profile owner, and/or the owner's agent, may modify meta-data processing options from different locations.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the particular partitioning of functions that is shown in the figures is presented for illustration purposes. Each device controller 250 of FIG. 2, for example, may be located at either the meta-information processing system 200, or at the content rendering device 170 of FIG. 1, or distributed between the two elements 200, 170, or provided as an independent unit, or as a component to a multi-device controller. In like manner, the meta-information renderer 230 of FIG. 2 may be the same device as the content rendering device 170 of FIG. 1, distributed between the content rendering device 170 and the processor 220, located on a separate system, and so on. These and other system configuration and optimization features will be evident to one of ordinary skill in the art in view of this disclosure, and are included within the scope of the following claims.

I claim:

1. A system comprising:
a source of content material,
a source of meta-information,
a combiner, operably coupled to the source of the content material and the source of the meta-information that is configured to combine the content material and the meta-information to form a composite data set, and
an interface to a broadcaster that is configured to broadcast the composite data set to one or more receivers,
wherein
the meta-information is configured to facilitate subsequent processing of information contained in the meta-information.

2. The system of claim , wherein
the broadcaster includes at least one of: an RF transmitter, a multiplexer, an Internet server, a cable headend, and a recording system.

3. The system of claim 1, wherein
the meta-information is encoded using an Extended Markup Language.

4. The system of claim 1, wherein
the meta-information is further configured to facilitate a subsequent access to at least one of: other content material and other sources of information.

5. The system of claim 1, wherein
the meta-information is further configured to facilitate a purchase transaction to effect the access to the other material.

6. The system of claim 1, wherein
the meta-information is further configured to facilitate obtaining at least one of: select content material, and material related to the content material.

7. The system of claim 4, wherein
the meta-information is further configured to facilitate a purchase transaction to effect the obtaining of material.

8. The system of claim 1, wherein
the meta-information includes at least one of: a scheduled broadcast time, an access channel, a script, a URL identifier, a source provider identification, purchase information, content processing instructions, and control codes.

9. A receiving system comprising:
a receiver that is configured to receive a composite data set that includes content material and meta-information,
a content rendering device, operably coupled to the receiver, that is configured to render the content material, and
at least one meta-information processor, operably coupled to the receiver, that is configured to process the meta-information so as to facilitate at least one of: a subsequent access to other material, a control of a device, and a transfer of information.

10. The receiving system of claim 9, further including at least one of:
a content access scheduler that is configure to schedule the subsequent access to the other material,
a device controller that is configured to control one or more devices to facilitate the subsequent access to the other material, and
an Internet access device that is configured to access one or more information sources, based on the meta-information.

11. The receiving system of claim 10, wherein at least one of the content access scheduler and the Internet access device is configured to facilitate obtaining select material, based on the meta-information.

12. The receiving system of claim 10, wherein at least one of the content access scheduler and the Internet access device is further configured to facilitate a purchase transaction to effect obtaining the select material.

13. The receiving system of claim 9, further including
a meta-information rendering device that is configured to render information based on the meta-information.

14. The receiving system of claim 13, wherein:
the meta-information rendering device is further configured to receive user input, and
the subsequent access to the other material is based on the user input.

15. The receiving system of claim 13, wherein
the content rendering device includes the meta-information rendering device.

16. The receiving system of claim 9, wherein
the subsequent access to the other material is based on a profile of user preferences.

17. A method of enhancing revenue, comprising:
providing a composite data set of content material and meta-information to a broadcaster for distribution to a plurality of users,
wherein the meta-information is provided to facilitate obtaining of material.

18. The method of claim 17, further including:
facilitating a purchase transaction to effect the obtaining of material.

19. The method of claim 17, wherein
the meta-information includes information that facilitates a subsequent access to select material.

20. The method of claim 17, wherein
the meta-information includes information that facilitates a subsequent access to information related to the content material.

21. The method of claim 17, wherein
the meta-information includes at least one of: a scheduled broadcast time, an access channel, a URL identifier, a source provider identification, purchase information, content processing instructions, and control codes.

22. An encoded signal, comprising:
content material, and
meta-information,
wherein
the meta-information is configured to facilitate subsequent processing of information contained in the meta-information.

23. The encoded signal of claim 22, wherein
the meta-information is configured so as to facilitate the subsequent processing to effect at least one of: a subsequent access to other material, a control of a device, and a transfer of information.

24. The encoded signal of claim 22, wherein
the meta-information is related to the content material.
